(19) United States
(12) Patent Application Publication
(10) Pub. No.: US 2007/0035496 A1
(43) Pub. Date: Feb. 15, 2007

(54) DRIVING CIRCUITS

(75) Inventors: Wei-Min Sun, Taipei City (TW); I-Hsin Lo, Taichung County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORP., Hsinchu 300 (TW)

(21) Appl. No.: 11/419,007

(22) Filed: May 18, 2006

(30) Foreign Application Priority Data
Aug. 12, 2005 (TW) 94127504

(51) Int. Cl. G09G 3/36

(52) U.S. Cl. 345/87

(57) ABSTRACT

Driving circuits capable of outputting video data or OSD data selectively are used to serve as images on a display. The driving circuit which is integrated in a display panel comprises a selection unit that receives video data and on-screen-display (OSD) data and outputs the video data and the ODS data selectively according to a control signal, and a digital-to-analog conversion unit that converts the video data or the OSD data to an analog signal to drive a pixel array.

### BACKGROUND OF THE INVENTION

1. Field of the Invention

The invention relates to driving circuits, and in particular to a driving circuit integrated into a display panel capable of outputting video data or OSD data selectively to serve as images on a display.

2. Description of the Related Art

High definition, multicolor display, low power consumption, lower voltage requirements and light weight have made liquid crystal displays (LCDs) to be a leading display device technology. Further, On-Screen-Display (OSD) function is widely applied in display devices to adjust settings of the display devices. However, in display devices using digital interface, in order to implement OSD function, external printed circuits further require a switching IC to select video data or OSD data selectively to serve as images on a display, except for an OSD integrated circuit. This increases external printed circuit board and design complexity.

### BRIEF SUMMARY OF THE INVENTION

A detailed description is given in the following embodiments with reference to the accompanying drawings.

Embodiments of driving circuits integrated in a display panel are provided, in which a selection unit receives video data and on-screen-display (OSD) data and outputs the video data and the ODS data selectively according to a control signal and a digital-to-analog conversion unit converts the video data or the OSD data to an analog signal to drive a pixel array.

The invention also provides embodiments of a driving module, in which a printed circuit board comprises an on-screen-display (OSD) integrated circuit to generate OSD data and a control signal according to a horizontal synchronicity signal and a vertical synchronicity signal, and a driving circuit integrated into a display panel and coupled to a display array and the printed circuit board. The driving circuit comprises a selection unit receiving video data and the OSD data and outputting the video data and the ODS data selectively according to the control signal, and a digital-to-analog conversion unit converting the video data or the OSD data to an analog signal to drive the pixel array.

The invention also provides embodiments of a display system, in which a printed circuit board comprises an on-screen-display (OSD) integrated circuit to generate OSD data and a control signal according to a horizontal synchronicity signal and a vertical synchronicity signal, and a display panel coupled to the printed circuit board and comprising a driving circuit and a display array. The driving circuit comprises a selection unit receiving video data and the OSD data and outputting the video data and the ODS data selectively according to the control signal, and a digital-to-analog conversion unit converting the video data or the OSD data to an analog signal to drive the pixel array.

The invention also provides embodiments of electronic devices, in which the disclosed display system is provided and a power supply powers the display system to display images.

### BRIEF DESCRIPTION OF THE DRAWINGS

The invention can be more fully understood by reading the subsequent detailed description and examples with references made to the accompanying drawings, wherein:

FIG. 1A shows an embodiment of a display system of the invention;

FIG. 1B shows another embodiment of a display system of the invention;

FIG. 2 shows a relationship table related to external control signal and gray level multiplier; and

FIG. 3 is a schematic view of an electronic device using display systems shown in FIGS. 1A and 1B.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

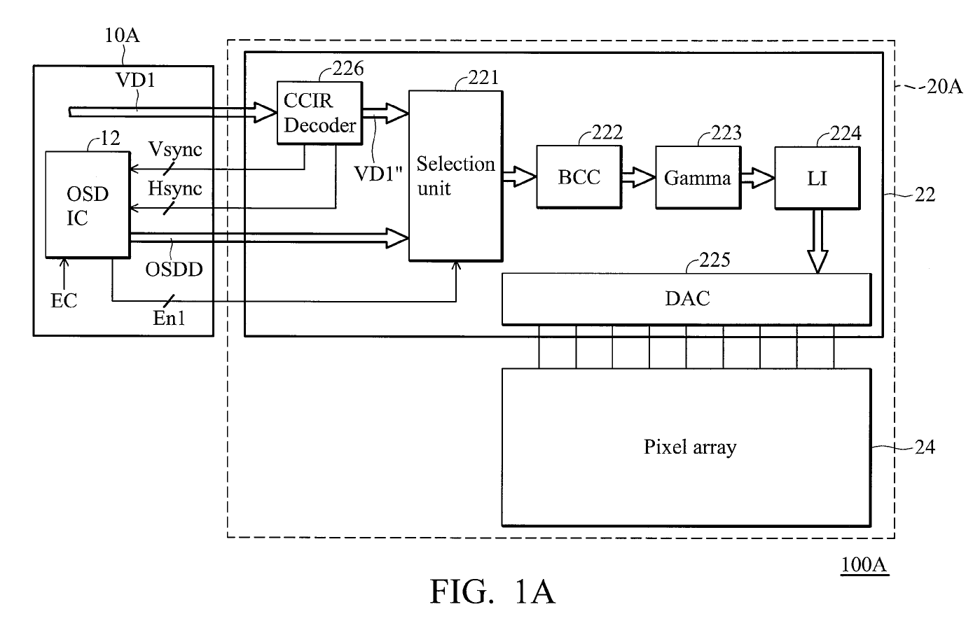

FIG. 1A shows an embodiment of a display system of the invention. As shown, the display system 100A comprises a printed circuit board 10A and a display panel 20A.

The printed circuit board 10A comprises an on-screen-display (OSD) integrated circuit 12 generating OSD data OSDD and a control signal En1 according to a horizontal synchronicity signal Hsync and a vertical synchronicity signal Vsync.

The display panel 20A is coupled to the printed circuit board 10A and comprises a driving circuit 22 and a display array 24. For example, the display panel 20A can be a liquid crystal display panel, a plasma display panel or an organic light emitting display panel, but is not limited thereto. The driving circuit 22 comprises a selection unit 221, a brightness contrast controller 222, a gamma correction unit 223, line inversion controller 224, a digital-to-analog converter 225 and a Consultative Committee of International Radio (CCIR) decoder 226. For example, the driving circuit 22 can be a data driver, wherein the pixel array 24 comprises a plurality of pixels (not shown) arranged in matrix and displays images according to analog signals from the digital-analog converter 225.

The CCIR decoder 226 decodes video data VD″, the horizontal synchronicity signal Hsync and the vertical synchronicity signal Vsync according to video input VD1, and outputs to the OSD integrated circuit 12 and the selection unit 221 respectively. For example, the video input VD1 can meet with a CCIR656 format.

The selection unit 221 receives the video data OSDD from the OSD integrated circuit 12 and the video data VD″ from the CCIR decoder 226, and outputs them selectively according to the control signal En1. For example, the selection unit 221 can be a multiplexer or a switching unit, but is not limited thereto.

The brightness contrast controller 222 controls brightness and contrast of the display panel 20A, the gamma correction unit 223 adjusts non-linearity of the display panel 20A, and the line inversion controller 224 controls line inversion of the display panel 20A. The digital-to-analog converter 225 converts the video data VD″ or OSDD from the selection unit 221 to corresponding analog signals for driving display array 24.

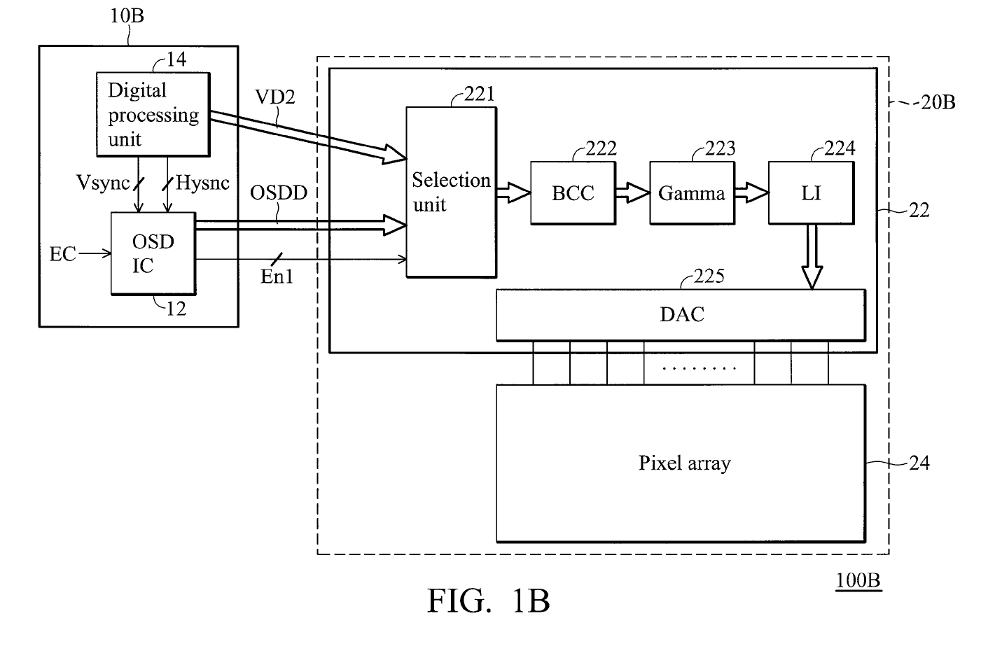

Moreover, the OSD integrated circuit 12 further comprises a built-in storage unit (not shown) to store a relationship table (shown in FIG. 2). The OSD integrated circuit 12 can adjust the corresponding gray levels in the OSD data OSDD according to the relationship table and an external control signal EC. For example, when receiving the OSDD data, the OSD integrated circuit 12 sets the gray level multiplier of 0.25 if the external control signal EC is 00. If the external control signal EC is 01, 10 and 11 respectively, the OSD integrated circuit 12 sets the gray level multiplier at 0.50, 0.75 and 1.00 respectively. When receiving no OSDD data, the OSD integrated circuit 12 sets the gray level multiplier to be zero, no matter what the external control signal EC is. Namely, gray levels in the OSD data OSDD can be adjusted according to the external control signal EC.

FIG. 1B shows another embodiment of a display system of the invention. As shown, the display system 100B comprises a printed circuit board 10B and a display panel 20B.

The printed circuit board 10A comprises an on-screen-display (OSD) integrated circuit 12 and a digital processing unit 14. The digital processing unit 14 generates video data VD2, a horizontal synchronicity signal Hsync and a vertical synchronicity signal Vsync, and the OSD integrated circuit 12 generates the OSD data OSDD and a control signal En1 according to the horizontal synchronicity signal Hsync and the vertical synchronicity signal Vsync.

The display panel 20B is coupled to the printed circuit board 10B and comprises a driving circuit 22 and a display array 24. For example, the display panel 20A can be a liquid crystal display panel, a plasma display panel or an organic light emitting display panel, but is not limited thereto. The driving circuit 22 comprises a selection unit 221, a brightness contrast controller 222, a gamma correction unit 223, line inversion controller 224, and a digital-to-analog converter 225. For example, the driving circuit 22 can be a data driver, and the pixel array 24 comprises a plurality of pixels (not shown) arranged in matrix and display images according to analog signals from the digital-analog converter 225.

The selection unit 221 receives the video data OSDD from the OSD integrated circuit 12 and the video data VD2 from the digital processing unit 14 and outputs them selectively according to the control signal En1. For example, the selection unit 221 can be a multiplexer or a switching unit, but is not limited thereto.

The brightness contrast controller 222 controls brightness and contrast of the display panel 20B, the gamma correction unit 223 adjusts non-linearity of the display panel 20B, and the line inversion controller 224 controls line inversion of the display panel 20B. The digital-to-analog converter 225 converts the video data VD2 or OSDD from the selection unit 221 to corresponding analog signals to drive display array 24.

Similarly, the OSD integrated circuit 12 further comprises a built-in storage unit (not shown) to store a relationship table (shown in FIG. 2). The OSD integrated circuit 12 can adjust the corresponding gray levels in the OSD data OSDD according to the relationship table and an external control signal EC. For example, when receiving the OSDD data, the OSD integrated circuit 12 sets the gray level multiplier of 0.25 if the external control signal EC is 00. If the external control signal EC is 01, 10 and 11, the OSD integrated circuit 12 sets the gray level multiplier at 0.50, 0.75 and 1.00 respectively. When receiving no OSDD data, the OSD integrated circuit 12 sets the gray level multiplier to be zero no matter what the external control signal EC is. Namely, gray levels in the OSD data OSDD can be adjusted according to the external control signal EC.

Thus, the invention integrates the selection unit switching signals to the display panel, such that complication of the external printed circuit board is simplified and cost is reduced.

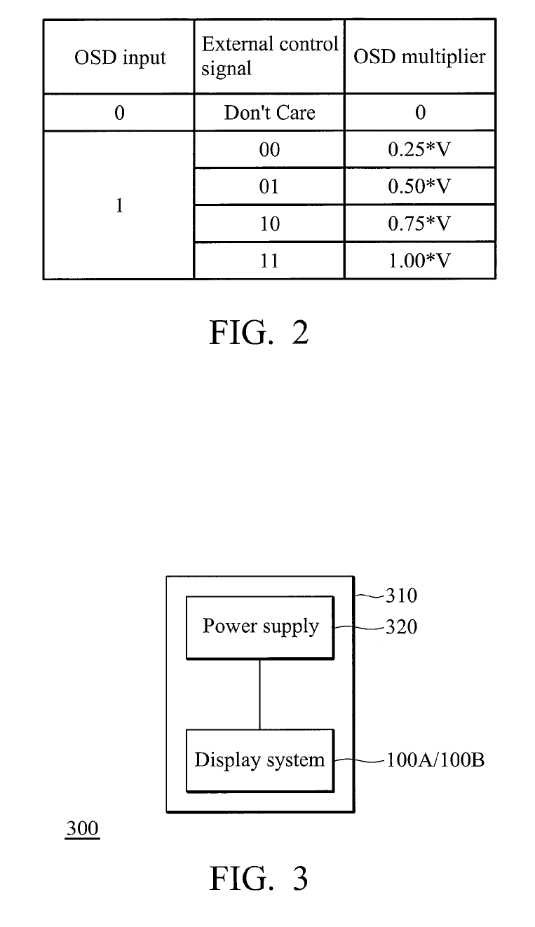

FIG. 3 is a schematic view showing an electronic device using display systems shown in FIGS. 1A and 1B. As shown, the electronic device 300 comprises a housing 310, the display system 10A or 100B, and power supply 320. The power supply 320 powers the display system 100A or 100B to display images. For example, the display system 100A or 100B can be a liquid crystal display panel, a plasma display panel or a organic light emitting display panel, and the electronic device 300 can be a PDA, a display monitor, a notebook computer, a table computer or a cellular phone.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving circuit, integrated into a display panel, comprising
a selection unit receiving video data and on-screen-display (OSD) data and outputting the video data and the ODS data selectively according to a control signal; and
a digital-to-analog conversion unit converting the video data or the OSD data to an analog signal to drive a pixel array.

2. The driving circuit as claimed in claim 1, further comprising a decoding unit decoding the video data, a horizontal synchronicity signal and a vertical synchronicity signal according to a video input.

3. The driving circuit as claimed in claim 2, wherein the video input meets with a CCIR656 format.

4. The driving circuit as claimed in claim 1, wherein the OSD data and the control signal are output from an OSD integrated circuit on an external printed circuit board.

5. The driving circuit as claimed in claim 1, wherein the video data is output from a digital processing unit on an external printed circuit board.

6. The driving circuit as claimed in claim 5, wherein the OSD data and the control signal are output from an OSD integrated circuit on an external printed circuit board.

7. The driving circuit as claimed in claim 4, wherein the OSD integrated circuit adjusts gray levels of the OSD data according to an external control signal.

8. The driving circuit as claimed in claim 1, wherein the selection unit is a multiplexer or a switch.

9. A driving module, comprising
a printed circuit board, comprising an on-screen-display (OSD) integrated circuit to generate OSD data and a control signal according to a horizontal synchronicity signal and a vertical synchronicity signal; and
a driving circuit integrated into a display panel and coupled to a display array and the printed circuit board, comprising:
a selection unit receiving video data and the OSD data and outputting the video data and the ODS data selectively according to the control signal; and
a digital-to-analog conversion unit converting the video data or the OSD data to an analog signal to drive the pixel array.

10. The driving module as claimed in claim 9, wherein the driving circuit further comprises a decoding unit decoding the video data, the horizontal synchronicity signal and the vertical synchronicity signal according to a video input.

11. The driving module as claimed in claim 10, wherein the video input meets with a CCIR656 format.

12. The driving module as claimed in claim 9, wherein printed circuit board further comprises a digital processing unit to generate the video data, the horizontal synchronicity signal and the vertical synchronicity signal.

13. The driving module as claimed in claim 9, wherein the OSD integrated circuit adjusts gray levels of the OSD data according to an external control signal.

14. The driving module as claimed in claim 9, wherein the selection unit is a multiplexer or a switch.

15. A display system, comprising
a printed circuit board, comprising an on-screen-display (OSD) integrated circuit to generate OSD data and a control signal according to a horizontal synchronicity signal and a vertical synchronicity signal; and
a display panel coupled to the printed circuit board, comprising a driving circuit and a display array, wherein the driving circuit comprises:
a selection unit receiving video data and the OSD data and outputting the video data and the ODS data selectively according to the control signal; and
a digital-to-analog conversion unit converting the video data or the OSD data to an analog signal to drive the pixel array.

16. The display system as claimed in claim 15, wherein the driving circuit further comprises a decoding unit decoding the video data, the horizontal synchronicity signal and the vertical synchronicity signal according to a video input.

17. The display system as claimed in claim 16, wherein the video input meets with a CCIR656 format.

18. The display system as claimed in claim 15, wherein the printed circuit board further comprises a digital processing unit to generate the video data, the horizontal synchronicity signal and the vertical synchronicity signal.

19. The display system as claimed in claim 15, wherein the display panel comprises a liquid crystal display panel.

20. The display system as claimed in claim 15, wherein the OSD integrated circuit adjusts gray levels of the OSD data according to an external control signal.

21. The display system as claimed in claim 15, wherein the selection unit is a multiplexer or a switch.

22. An electronic device, comprising:
a display system, comprising:
a printed circuit board, comprising an on-screen-display (OSD) integrated circuit to generate OSD data and a control signal according to a horizontal synchronicity signal and a vertical synchronicity signal; and
a display panel coupled to the printed circuit board, comprising a driving circuit and a display array, wherein the driving circuit comprises:
a selection unit receiving video data and the OSD data and outputting the video data and the ODS data selectively according to the control signal; and
a digital-to-analog conversion unit converting the video data or the OSD data to an analog signal to drive the pixel array; and
a power supply powering the display system to display images.

23. The electronic device as claimed in claim 22, wherein the display panel is a liquid crystal display panel, a plasma display panel or a organic light emitting display panel.
